(19) United States
(12) Patent Application Publication
(10) Pub. No.: US 2019/0071973 A1
(43) Pub. Date: Mar. 7, 2019

(54) ROTATING BODY AND TURBOCHARGER

(71) Applicant: IHI Corporation, Koto-ku (JP)

(72) Inventors: Ryota Sakisaka, Tokyo (JP); Takahiro Kobayashi, Tokyo (JP); Shinichi Kaneda, Tokyo (JP); Kenji Bunno, Tokyo (JP)

(73) Assignee: IHI Corporation, Koto-ku (JP)

(21) Appl. No.: 16/177,988

(22) Filed: Nov. 1, 2018

Related U.S. Application Data
(63) Continuation of application No. PCT/JP2017/016222, filed on Apr. 24, 2017.

(30) Foreign Application Priority Data
May 25, 2016 (JP) 2016-103876

(51) Int. Cl. F01D 5/02; F04D 29/26

(52) U.S. Cl. CPC F01D 5/025; F02B 37/02; F04D 29/263

(57) ABSTRACT

Provided is a rotating body, comprising: an impeller including: a main body portion; a welded surface formed on a back surface of the main body portion; a recessed portion, which is formed in the main body portion on a radially inner side with respect to the welded surface; and a reinforcing portion, which is formed on the main body portion on the radially inner side with respect to the recessed portion; and a shaft including: a welding surface welded to the welded surface; and a projection portion, which is formed on the radially inner side with respect to the welding surface, projects toward the impeller side with respect to the welding surface, and is inserted into the recessed portion, the shaft receiving a distal end of the reinforcing portion inserted thereinto on the radially inner side with respect to the projection portion.

### CROSS REFERENCE TO RELATED APPLICATIONS

This application is a continuation application of International Application No. PCT/JP2017/016222, filed on Apr. 24, 2017, which claims priority to Japanese Patent Application No. 2016-103876, filed on May 25, 2016, the entire contents of which are incorporated by reference herein.

### BACKGROUND ART

### Technical Field

The present disclosure relates to a rotating body including a shaft and an impeller, and to a turbocharger.

### Related Art

Hitherto, there has been known a turbocharger in which a shaft is axially supported so as to be rotatable in a bearing housing. A turbine impeller is provided at one end of the shaft. A compressor impeller is provided at another end of the shaft. Such a turbocharger is connected to an engine. The turbine impeller is rotated by exhaust gas discharged from the engine. The rotation of the turbine impeller causes the compressor impeller to rotate through the shaft. In such a manner, the turbocharger compresses air along with the rotation of the compressor impeller and delivers the compressed air to the engine.

In Patent Literature 1, there is described a welding structure of an impeller and a shaft. Specifically, an insertion portion formed at a distal end of the shaft is inserted into a recessed portion formed in a back surface of the impeller. Moreover, on a base end side of the insertion portion of the shaft, a welding surface is formed at a part projecting radially outward with respect to the recessed portion. The welding surface of the shaft is brought into abutment against the back surface of the impeller in an axial direction. The welding surface is welded by an electron beam.

### CITATION LIST

### Patent literature

Patent Literature 1: Japanese Patent Application Laid-Open No. 2013-194528

### SUMMARY

### Technical Problem

Incidentally, the impeller has an outer diameter larger than an outer diameter of the shaft. A centrifugal force which acts on the impeller becomes larger than a centrifugal force which acts on the shaft. Therefore, when a difference in displacement between the impeller and the shaft due to the centrifugal force at a welded portion increases, there is a tendency of causing stress concentration. For example, in the configuration of Patent Literature 1, a space which is recessed in the axial direction is formed in the insertion portion of the shaft so that the rigidity of the shaft at the welded portion is reduced. The shaft becomes more likely to follow displacement of the impeller, thereby suppressing the increase in difference in displacement between the impeller and the shaft. However, in order to meet future demands such as increase in rotation speed of the shaft, it is required that stress concentration at the welded portion between the shaft and the impeller be further alleviated.

It is an object of the present disclosure to provide a rotating body and a turbocharger, which are capable of alleviating stress concentration at a welded portion between a shaft and an impeller.

### Solution to Problem

In order to achieve the above-mentioned object, according to one embodiment of the present disclosure, there is provided a rotating body, comprising: an impeller including: a main body portion; a welded surface formed on a back surface of the main body portion; a recessed portion, which is formed in the main body portion on a radially inner side with respect to the welded surface, and is recessed with respect to the welded surface; and a reinforcing portion, which is formed on the main body portion on the radially inner side with respect to the recessed portion, and projects from a bottom surface of the recessed portion; and a shaft including: a welding surface welded to the welded surface; and a projection portion, which is formed on the radially inner side with respect to the welding surface, projects toward the impeller side with respect to the welding surface, and is inserted into the recessed portion, the shaft receiving a distal end of the reinforcing portion inserted thereinto on the radially inner side with respect to the projection portion.

The welded surface may project with respect to an outermost peripheral portion of the main body portion located on an outermost side in the radial direction.

The recessed portion and the projection portion may each have an annular shape.

The reinforcing portion may have a projection height equal to or larger than a projection height of the welded surface.

The projection portion may be formed continuously on the welding surface, and a surface of the projection portion on a radially outer side may be brought into abutment against an inner wall surface of the recessed portion.

In order to achieve the above-mentioned object, according to one embodiment of the present disclosure, there is provided a turbocharger, including the rotating body described above.

### Effects of Disclosure

According to the present disclosure, the stress concentration at the welded portion between the shaft and the impeller can be alleviated.

### BRIEF DESCRIPTION OF DRAWINGS

FIG. 1 is a schematic sectional view of a turbocharger.

FIG. 2 is an explanatory view for illustrating a turbine shaft.

FIG. 3A is an illustration of a shaft as seen in a direction indicated by an arrow IIIa in FIG. 3B.

FIG. 3B is an extraction view for illustrating a structure of a cross section including a center axis of the shaft at a part indicated by the broken line IIIb in FIG. 2.

FIG. 4 is an enlarged extraction view of the part indicated by the broken line in FIG. 3B.

FIG. 5A is an illustration of a shaft as seen in a direction indicated by an arrow Va in FIG. 5B.

FIG. 5B is an illustration of a cross section at a part corresponding to FIG. 3B in a first modification example.

FIG. 6A is an illustration of a shaft as seen in a direction indicated by an arrow VIa in FIG. 6B.

FIG. 6B is an illustration of a cross section at a part corresponding to FIG. 3B in a second modification example.

### DESCRIPTION OF EMBODIMENT

Now, with reference to the attached drawings, an embodiment of the present disclosure is described in detail. The dimensions, materials, and other specific numerical values represented in the embodiment are merely examples used for facilitating the understanding, and do not limit the present disclosure otherwise particularly noted. Elements having substantially the same functions and configurations herein and in the drawings are denoted by the same reference symbols to omit redundant description thereof. Further, illustration of elements with no direct relationship to the present disclosure is omitted.

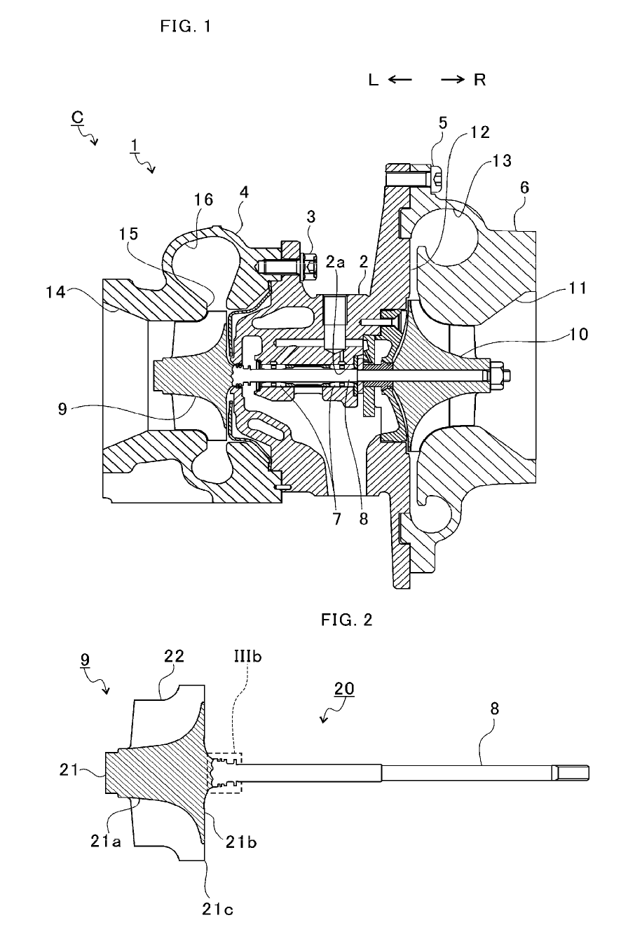

FIG. 1 is a schematic sectional view of a turbocharger C. In the following description, the direction indicated by the arrow L illustrated in FIG. 1 corresponds to a left side of the turbocharger C. The direction indicated by the arrow R illustrated in FIG. 1 corresponds to a right side of the turbocharger C. As illustrated in FIG. 1, the turbocharger C includes a turbocharger main body 1. The turbocharger main body 1 includes a bearing housing 2. A turbine housing 4 is mounted to one end surface of the bearing housing 2 on the left side by a fastening bolt 3. A compressor housing 6 is mounted to one end surface of the bearing housing 2 on the right side by a fastening bolt 5.

The bearing housing 2 has a bearing hole 2a. The bearing hole 2a penetrates through the bearing housing 2 in a right-and-left direction of the turbocharger C. A radial bearing 7 (in this embodiment, a full-floating bearing is illustrated in FIG. 1 as an example) is provided in the bearing hole 2a. A shaft 8 is axially supported by the radial bearing 7 so as to be rotatable. A turbine impeller 9 (impeller) is provided at a left end portion of the shaft 8. The turbine impeller 9 is received in the turbine housing 4 so as to be rotatable. Moreover, a compressor impeller 10 is provided at a right end portion of the shaft 8. The compressor impeller 10 is received in the compressor housing 6 so as to be rotatable.

The compressor housing 6 has a suction port 11. The suction port 11 is opened on the right side of the turbocharger C. The suction port 11 is connected to an air cleaner (not shown). Moreover, under a state in which the bearing housing 2 and the compressor housing 6 are coupled to each other by the fastening bolt 5, a diffuser flow passage 12 is formed. The diffuser flow passage 12 is formed by opposed surfaces of the bearing housing 2 and the compressor housing 6. The diffuser flow passage 12 increases pressure of air. The diffuser flow passage 12 is annularly formed so as to extend from an inner side toward an outer side in a radial direction of the shaft 8. The diffuser flow passage 12 communicates with the suction port 11 through intermediation of the compressor impeller 10 on the inner side in the radial direction of the shaft 8.

Further, the compressor housing 6 has a compressor scroll flow passage 13. The compressor scroll flow passage 13 has an annular shape. The compressor scroll flow passage 13 is located on the radially outer side of the shaft 8 with respect to the diffuser flow passage 12. The compressor scroll flow passage 13 communicates with a suction port of an engine (not shown). The compressor scroll flow passage 13 communicates also with the diffuser flow passage 12. Thus, when the compressor impeller 10 is rotated, air is sucked into the compressor housing 6 through the suction port 11. The sucked air is increased in speed by an action of the centrifugal force during a course of flowing through blades of the compressor impeller 10. The air increased in speed is increased in pressure in the diffuser flow passage 12 and the compressor scroll flow passage 13, and is introduced to the suction port of the engine.

The turbine housing 4 has a discharge port 14. The discharge port 14 is opened on the left side of the turbocharger C. The discharge port 14 is connected to an exhaust gas purification device (not shown). Moreover, a flow passage 15 and a turbine scroll flow passage 16 are formed in the turbine housing 4. The turbine scroll flow passage 16 has an annular shape. The turbine scroll flow passage 16 is located on an outer side in a radial direction of the turbine impeller 9 with respect to the flow passage 15. The turbine scroll flow passage 16 communicates with a gas inflow port (not shown). Exhaust gas discharged from an exhaust gas manifold (not shown) of the engine is introduced to the gas inflow port. The turbine scroll flow passage 16 communicates also with the flow passage 15. Thus, the exhaust gas introduced through the gas inflow port to the turbine scroll flow passage 16 is introduced to the discharge port 14 through the flow passage 15 and the blades (plurality of fins 22 described later) of the turbine impeller 9. The air introduced to the discharge port 14 causes the turbine impeller 9 to rotate during a course of flowing.

Then, a rotational force of the turbine impeller 9 is transmitted to the compressor impeller 10 through the shaft 8. As described above, the air is increased in pressure due to the rotational force of the compressor impeller 10, and is introduced to the suction port of the engine.

FIG. 2 is an explanatory view for illustrating a turbine shaft 20 (rotating body). As illustrated in FIG. 2, the turbine shaft 20 includes the shaft 8 and the turbine impeller 9 of, for example, a radial type. A main body portion 21 (hub portion) of the turbine impeller 9 is radially expanded in a rotation axis direction of the turbine shaft 20 (hereinafter simply referred to as “rotation axis direction”) from the left side (one side) toward the right side (another side) in FIG. 2.

The main body portion 21 has an outer peripheral surface 21a oriented toward the one side in the rotation axis direction. The main body portion 21 has a back surface 21b oriented toward the another side in the rotation axis direction. The outer peripheral surface 21a and the back surface 21b each have, for example, a circular outer shape as seen in the rotation axis direction. The outer peripheral surface 21a of the main body portion 21 is gradually increased in outer diameter toward the another side in the rotation axis direction.

The outer peripheral surface 21a has the plurality of fins 22. The plurality of fins 22 are separated apart from one another in a circumferential direction of the outer peripheral surface 21a. The plurality of fins 22 project from the outer peripheral surface 21a in the radial direction.

Moreover, a radially inner side of the back surface 21b of the main body portion 21 projects in the rotation axis direction. The part of the back surface 21b on the radially inner side projects toward the shaft 8 side (compressor impeller 10 side, that is, the right side in FIG. 2) with respect to the position at which the turbine impeller 9 (fins 22) extends in the axial direction. For example, in the case of the turbine impeller of the radial type, as illustrated in FIG. 2, the part of the back surface 21b on the radially inner side projects toward the right side with respect to an outermost peripheral portion 21c (portion at which an outer diameter of the main body portion 21 is maximum) that is located on the most radially outer side of the turbine impeller 9.

The shaft 8 is welded to the above-mentioned projection portion on the back surface 21b of the main body portion 21. In such a manner, the shaft 8 is joined to the back surface 21b of the main body portion 21 of the turbine impeller 9.

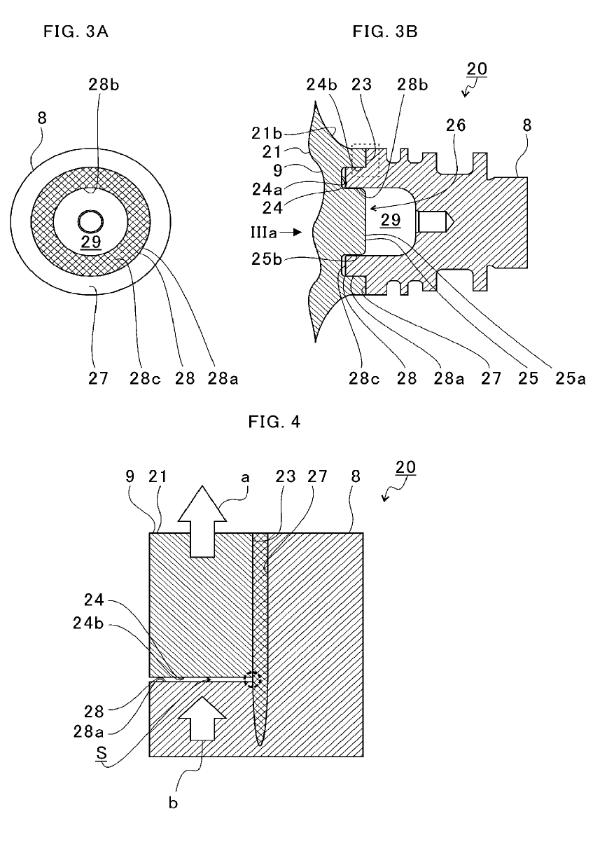

FIG. 3A is an illustration of the shaft 8 as seen in a direction indicated by an arrow IIIa in FIG. 3B. FIG. 3B is an extraction view for illustrating a structure of a cross section including a center axis of the shaft 8 at a part indicated by the broken line IIIb in FIG. 2.

As illustrated in FIG. 3B, a welded surface 23 is formed on the back surface 21b of the main body portion 21 of the turbine impeller 9. The welded surface 23 has an annular shape. The welded surface 23 is welded to the shaft 8. The welded surface 23 projects in the rotation axis direction (toward the right side in FIG. 2 and FIG. 3B) with respect to the outermost peripheral portion 21c (see FIG. 2) of the main body portion 21 described above.

On the radially inner side of the portion at which an outer diameter of the main body portion 21 is maximum (in the example of the turbine impeller of the radial type illustrated in FIG. 2, substantially the same position as the outermost peripheral portion 21c), the main body portion 21 and the fins 22 extend to the radially outer side. The centrifugal force which acts during operation (during rotation of the turbine shaft 20) increases. Therefore, the welded portion between the shaft 8 and the turbine impeller 9 is located at a position apart from the maximum diameter portion (outermost peripheral portion 21c) of the main body portion 21 in the rotation axis direction (on the compressor impeller 10 side). In this case, displacement of the turbine impeller 9 due to the centrifugal force at the welded portion is suppressed. With this, the stress concentration can be alleviated.

On the radially inner side of the welded surface 23, there are formed a recessed portion 24 and a reinforcing portion 25. The recessed portion 24 is recessed in the rotation axis direction with respect to the welded surface 23. Similarly to the welded surface 23, the recessed portion 24 has an annular shape.

The reinforcing portion 25 is a part of the main body portion 21 on the radially inner side with respect to the recessed portion 24. The reinforcing portion 25 projects in the axial direction with respect to a bottom surface 24a of the recessed portion 24. A position of a distal end surface 25a (distal end) of the reinforcing portion 25 in the rotation axis direction is the same as a position of the welded surface 23 in the rotation axis direction.

In this case, for example, through formation of the annular groove (recessed portion 24) in a distal end surface 26 at a part of the back surface 21b of the turbine impeller 9 projecting in the rotation axis direction, the welded surface 23 and the reinforcing portion 25 can easily be formed.

Meanwhile, the shaft 8 has a welding surface 27. The welding surface 27 is opposed to the welded surface 23 of the turbine impeller 9 in the rotation axis direction. As illustrated in FIG. 3A, similarly to the welded surface 23, the welding surface 27 has an annular shape.

The welding surface 27 of the shaft 8 has a projection portion 28. The projection portion 28 projects in the rotation axis direction. The projection portion 28 is formed continuously on the radially inner side of the welding surface 27. The projection portion 28 projects in the rotation axis direction toward the turbine impeller 9 with respect to the welding surface 27.

As indicated by the cross-hatching in FIG. 3A, similarly to the recessed portion 24 of the turbine impeller 9, the projection portion 28 has an annular shape. A space 29 is formed on the radially inner side of the projection portion 28. The space 29 is formed at a part of the projection portion 28 which is recessed in the rotation axis direction with respect to the distal end surface 28c. The space 29 is formed of, for example, a hole which is formed in the shaft 8 and recessed in the rotation axis direction with respect to the welding surface 27.

The projection portion 28 is inserted into the recessed portion 24 of the turbine impeller 9. The distal end surface 25a of the reinforcing portion 25 is inserted into the space 29. Moreover, an outer peripheral surface 28a (surface on the radially outer side) of the projection portion 28 is fitted to an inner wall surface 24b of the recessed portion 24 on the radially outer side. Meanwhile, an inner peripheral surface 28b of the projection portion 28 is slightly separated apart in the radial direction with respect to the outer peripheral surface 25b of the reinforcing portion 25 of the turbine impeller 9.

In such a manner, the outer peripheral surface 28a of the projection portion 28 and the inner wall surface 24b of the recessed portion 24 are fitted to each other. Accordingly, positioning of the shaft 8 and the turbine impeller 9 is performed so that respective center axes are coaxial with each other.

Moreover, a projection height of the projection portion 28 (distance between the distal end surface 28c of the projection portion 28 and the welding surface 27) is smaller than a depth of the recessed portion 24 (distance between the bottom surface 24a of the recessed portion 24 and the welded surface 23). Therefore, when the projection portion 28 is inserted into the recessed portion 24, the welding surface 27 and the welded surface 23 are brought into abutment against each other under a state in which the distal end surface 28c of the projection portion 28 is separated apart from the bottom surface 24a of the recessed portion 24.

In such a manner, positioning of the shaft 8 and the turbine impeller 9 in the rotation axis direction is performed with the welding surface 27 of the shaft 8 and the welded surface 23 of the turbine impeller 9.

The welding surface 27 and the welded surface 23 are exposed on the outer peripheral side. An electron beam or laser light is radiated onto the welding surface 27 and the welded surface 23 from the outer peripheral side along the circumferential direction. Accordingly, the welding surface 27 and the welded surface 23 are welded to each other.

FIG. 4 is an enlarged extraction view of the part indicated by the broken line in FIG. 3B. In FIG. 4, the welded portion between the welding surface 27 of the shaft 8 and the welded surface 23 of the turbine impeller 9 is indicated by cross-hatching. During rotation of the turbine shaft 20, the amount of displacement due to a centrifugal stress which acts on the main body portion 21 of the turbine impeller 9 at the welded portion (indicated by the outlined arrow “a” in FIG. 4) is larger than the amount of displacement due to a centrifugal stress which acts on the shaft 8 (indicated by the outlined arrow “b” in FIG. 4). For example, Ni-based superalloy such as an Inconel material may be employed as a material of the turbine impeller 9, and high-strength carbon steel such as chrome-molybdenum steel may be employed as a material of the shaft 8.

Therefore, due to the centrifugal force which acts on the main body portion of the turbine impeller 9, the amount of displacement toward the upper side in FIG. 4 becomes larger in the inner wall surface 24b of the recessed portion 24 of the turbine impeller 9 than in the outer peripheral surface 28a of the projection portion 28 of the shaft 8. As illustrated in FIG. 4, a force acts in a direction of separating the outer peripheral surface 28a of the projection portion 28 and the inner wall surface 24b of the recessed portion 24 from each other in the radial direction. At the welded portion, the stress concentration occurs in the vicinity of the outer peripheral surface 28a of the projection portion 28 and the inner wall surface 24b of the recessed portion 24 (indicated by the circle of the broken line in FIG. 4).

For example, an insertion part of the shaft 8 to be inserted into the main body portion 21 of the turbine impeller 9 has a columnar shape. In this case, the rigidity of the insertion part of the shaft 8 is increased. The amount of displacement toward the upper side (in the radial direction) in FIG. 4 by which a part of the projection portion 28 corresponding to the outer peripheral surface 28a is displaced due to the centrifugal force which acts on the shaft 8 is reduced. In this embodiment, as illustrated in FIG. 3, the insertion part of the shaft 8 corresponds to the projection portion 28 having the annular shape. With this, the rigidity of the insertion part of the shaft 8 is reduced.

Moreover, in this embodiment, through insertion of the reinforcing portion 25 into the space 29, the rigidity of the main body portion 21 of the turbine impeller 9 is increased. Therefore, the amount of displacement toward the upper side (in the radial direction) in FIG. 4 by which the inner wall surface 24b of the recessed portion 24 is displaced due to the centrifugal force which acts on the turbine impeller 9 can be reduced. With this, the difference in displacement between the projection portion 28 and the recessed portion 24 is suppressed. The stress concentration can be alleviated.

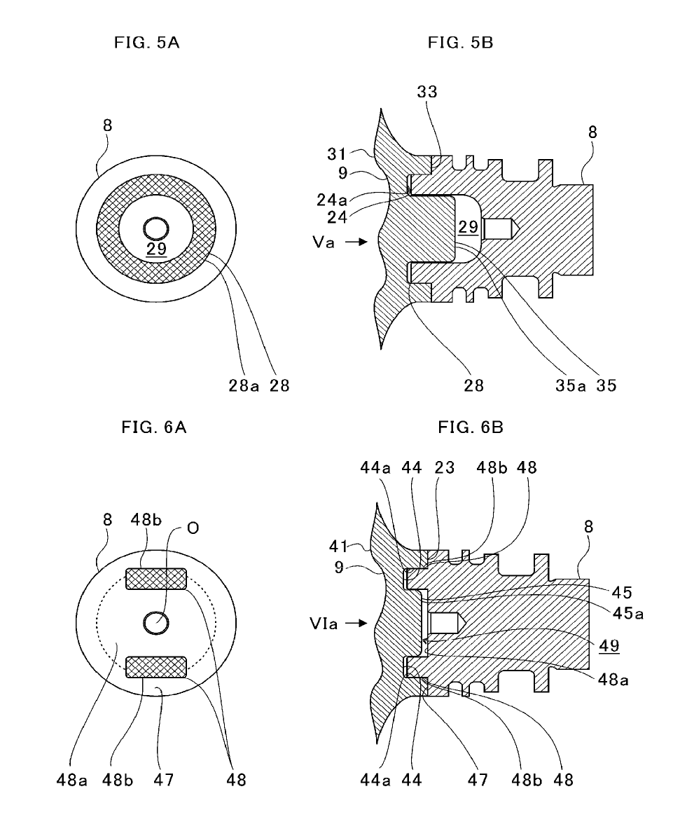

FIG. 5A is an illustration of the shaft 8 as seen in a direction indicated by an arrow Va in FIG. 5B. FIG. 5B is an illustration of a cross section at a part corresponding to FIG. 3B in a first modification example.

In the above-mentioned embodiment, description is made of the case in which the distal end surface 25a of the reinforcing portion 25 is approximately in flush with the welded surface 23. In the first modification example, as illustrated in FIG. 5B, a distal end surface 35a (distal end) of a reinforcing portion 35 projects toward the right side (space 29 side) in FIG. 5B with respect to a welded surface 33.

In this case, with the reinforcing portion 35 which projects with respect to the welded surface 33, the rigidity of the main body portion 31 of the turbine impeller 9 can be further increased. Therefore, the difference in displacement between the projection portion 28 and the recessed portion 24 is suppressed. The stress concentration can be further alleviated.

FIG. 6A is an illustration of the shaft 8 as seen in a direction indicated by an arrow VIa in FIG. 6B. FIG. 6B is an illustration of a cross section at a part corresponding to FIG. 3B in a second modification example.

In the above-mentioned embodiment and the first modification example, description is made of the case in which the recessed portion 24 and the projection portion 28 each have an annular shape. In the second modification example, as illustrated in FIG. 6A, a projection portion 48 has an approximately rectangular shape as seen in the rotation axis direction. Two projection portions 48 are formed in an axial symmetry over a center axis O of the shaft 8 as an example.

Moreover, similarly to the projection portion 48, a recessed portion 44 of the turbine impeller 9 has an approximately rectangular shape as seen in the rotation axis direction. Two recessed portions 44 are formed at positions opposed to the projection portions 48 across a rotation axis center of the turbine impeller 9. The two projection portions 48 are inserted into the two recessed portions 44, respectively.

Moreover, a reinforcing portion 45 is formed between the two recessed portions 44 of the main body portion 41 of the turbine impeller 9. A distal end surface 45a (distal end) of the reinforcing portion 45 is located on the left side in FIG. 6B with respect to the welded surface 23 (projection height in the rotation axis direction is small).

Moreover, a welding surface 47 of the shaft 8 is formed on an outer peripheral side of the base end surface 48a. The base end surface 48a is a base end surface of the shaft 8 on which the projection portion 48 is formed upright. The projection portion 48 is formed continuously on the radially inner side of the welding surface 47. A surface 48b of the projection portion 48 on the radially outer side is fitted to an inner wall surface 44a of the recessed portion 44.

As illustrated in FIG. 6B, a space 49 is formed so as to include a space between the two projection portions 48 of the base end surface 48a. The distal end surface 45a of the reinforcing portion 45 is separated apart from the base end surface 48a of the shaft 8 in the rotation axis direction. For example, the shape of the reinforcing portion 45 may suitably be set for a region excluding the parts opposed to the two projection portions 48 in a region of the welding surface 47 on the radially inner side (inner side of the dotted line in FIG. 6A). For example, the reinforcing portion 45 having a rectangular shape may be formed between the two projection portions 48.

As described above, even when the projection portions 48 and the recessed portions 44 each have a rectangular shape, similarly to the embodiment and the first modification example described above, the difference in displacement between the projection portion 48 and the recessed portion 44 is suppressed. The stress concentration can be alleviated.

The embodiment has been described above with reference to the attached drawings, but, needless to say, the present disclosure is not limited to the embodiment described above. It is apparent that those skilled in the art may arrive at various alternations and modifications within the scope of claims, and those examples are construed as naturally falling within the technical scope of the present disclosure.

For example, in the embodiment and the modification example described above, description is made of the case in which the welded surface 23, 33 projects in the rotation axis direction with respect to the outermost peripheral portion 21c. However, a position of the welded surface 23, 33 may overlap with a position of the outermost peripheral portion 21c in the rotation axis direction.

Moreover, in the embodiment and the first modification example described above, description is made of the case in which the recessed portion 24 and the projection portion 28 each have an annular shape. When the recessed portion 24 and the projection portion 28 each have an annular shape, positioning of the shaft 8 and the turbine impeller 9 can be easily performed with the recessed portion 24 and the projection portion 28 so that respective center axes are coaxial with each other. Therefore, as compared to the case in which similar positioning is performed on the device side on which the shaft 8 and the turbine impeller 9 are held, ease of operation can be improved. However, as in the second modification example, the recessed portion 44 and the projection portion 48 may each have a shape other than the annular shape.

Moreover, in the embodiment and the first modification example described above, description is made of the case in which the reinforcing portion 25, 35 has a projection height equal to or larger than a projection height of the welded surface 23, 33. When the reinforcing portion 25, 35 is formed so as to have a projection height equal to or larger than a projection height of the welded surface 23, 33, the rigidity of the main body portion 21, 31 of the turbine impeller 9 is increased. The difference in displacement of the projection portion 28 and the recessed portion 24 is suppressed, thereby being capable of further alleviating the stress concentration. However, the reinforcing portion 25, 35 may have a projection height smaller than a projection height of the welded surface 23, 33.

Moreover, in the embodiment and the modification example described above, description is made of the case in which the projection portion 28, 48 is formed continuously on the welding surface 27, 47. Moreover, description is made of the case in which the outer peripheral surface 28a of the projection portion 28 and the surface 48b of the projection portion 48 on the radially outer side are fitted to the inner wall surface 24b of the recessed portion 24 and the inner wall surface 44a of the recessed portion 44, respectively. That is, description is made of the case in which positioning of the shaft 8 and the turbine impeller 9 is performed so that respective center axes are coaxial with each other by the outer peripheral surface 28a of the projection portion 28 and the surface 48b of the projection portion 48 on the radially outer side. However, the configuration is not limited to this. For example, positioning of the shaft 8 and the turbine impeller 9 may be performed so that respective center axes are coaxial with each other by the inner peripheral surface 28b of the projection portion 28 and the surface of the projection portion 48 on the radially inner side. Moreover, the fitting relationship of the projection portion 28 and the projection portion 48 may be the relationship of any one of loose fitting, tight fitting, and intermediate fitting.

With the configuration in which positioning is performed with the outer peripheral surface 28a of the projection portion 28 and the surface 48b of the projection portion 48 on the radially outer side, a clearance S (see FIG. 4) between the projection portion 28, 48 and the recessed portion 24, 44 can be set narrow (or to 0 (zero)). As a result, melted metal becomes less liable to enter the clearance S during welding. The welding quality can be improved.

Moreover, in the embodiment described above, description is made of the case in which the turbine impeller 9 is of the radial type. However, the turbine impeller 9 may be of a diagonal flow type or an axial flow type.

Moreover, in the embodiment described above, description is made of the case in which the outer peripheral surface 21a and the back surface 21b of the turbine impeller 9 each have a circular outer diameter as seen in the axial direction. However, the shape of the turbine impeller 9 is not limited to this. For example, it is not always required that the back surface 21 have a circular shape (full disc). In the back surface 21b, cutouts (scallops) may be formed between the plurality of fins 22.

Moreover, in the embodiment and the modification example described above, description is made of the turbine shaft 20 provided as a rotating body to the turbocharger C as an example. However, it is only required that the rotating body includes at least a shaft and an impeller. The rotating body may be provided to, for example, other turbine and compressor such as a gas turbine and a general-purpose compressor.

### INDUSTRIAL APPLICABILITY

The present disclosure is applicable to a rotating body including a shaft and an impeller, and to a turbocharger.

What is claimed is:

1. A rotating body, comprising:
an impeller including:
a main body portion;
a welded surface formed on a back surface of the main body portion;
a recessed portion, which is formed in the main body portion on a radially inner side with respect to the welded surface, and is recessed with respect to the welded surface; and
a reinforcing portion, which is formed on the main body portion on the radially inner side with respect to the recessed portion, and projects from a bottom surface of the recessed portion; and
a shaft including:
a welding surface welded to the welded surface; and
a projection portion, which is formed on the radially inner side with respect to the welding surface, projects toward the impeller side with respect to the welding surface, and is inserted into the recessed portion,
the shaft receiving a distal end of the reinforcing portion inserted thereinto on the radially inner side with respect to the projection portion.

2. A rotating body according to claim 1, wherein the welded surface projects with respect to an outermost peripheral portion of the main body portion located on an outermost side in the radial direction.

3. A rotating body according to claim 1, wherein the recessed portion and the projection portion each have an annular shape.

4. A rotating body according to claim 2, wherein the recessed portion and the projection portion each have an annular shape.

5. A rotating body according to claim 1, wherein the reinforcing portion has a projection height equal to or larger than a projection height of the welded surface.

6. A rotating body according to claim 2, wherein the reinforcing portion has a projection height equal to or larger than a projection height of the welded surface.

7. A rotating body according to claim 3, wherein the reinforcing portion has a projection height equal to or larger than a projection height of the welded surface.

8. A rotating body according to claim 4, wherein the reinforcing portion has a projection height equal to or larger than a projection height of the welded surface.

9. A rotating body according to claim 1, wherein the projection portion is formed continuously on the welding surface, and a surface of the projection portion on a radially outer side is brought into abutment against an inner wall surface of the recessed portion.

10. A rotating body according to claim 2, wherein the projection portion is formed continuously on the welding surface, and a surface of the projection portion on a radially outer side is brought into abutment against an inner wall surface of the recessed portion.

11. A rotating body according to claim 3, wherein the projection portion is formed continuously on the welding surface, and a surface of the projection portion on a radially outer side is brought into abutment against an inner wall surface of the recessed portion.

12. A rotating body according to claim 4, wherein the projection portion is formed continuously on the welding surface, and a surface of the projection portion on a radially outer side is brought into abutment against an inner wall surface of the recessed portion.

13. A rotating body according to claim 5, wherein the projection portion is formed continuously on the welding surface, and a surface of the projection portion on a radially outer side is brought into abutment against an inner wall surface of the recessed portion.

14. A rotating body according to claim 6, wherein the projection portion is formed continuously on the welding surface, and a surface of the projection portion on a radially outer side is brought into abutment against an inner wall surface of the recessed portion.

15. A rotating body according to claim 7, wherein the projection portion is formed continuously on the welding surface, and a surface of the projection portion on a radially outer side is brought into abutment against an inner wall surface of the recessed portion.

16. A rotating body according to claim 8, wherein the projection portion is formed continuously on the welding surface, and a surface of the projection portion on a radially outer side is brought into abutment against an inner wall surface of the recessed portion.

17. A turbocharger, comprising the rotating body of claim 1.
